(19) United States
(12) Patent Application Publication
(10) Pub. No.: US 2004/0161960 A1
(43) Pub. Date: Aug. 19, 2004

(54) Vehicle-installed relay box

(75) Inventors: Kouichi Takagi, Aichi (JP); Keizou Ikeda, Aichi (JP); Shuji Mayama, Aichi (JP)

Correspondence Address: OLIFF & BERRIDGE, PLC, P.O. BOX 19928, ALEXANDRIA, VA, 22320, US

(73) Assignees: AUTONETWORKS TECHNOLOGIES, LTD., Nagoya-shi (JP); SUMITOMO WIRING SYSTEMS, LTD., Yokkaichi-shi (JP); SUMITOMO ELECTRIC INDUSTRIES, LTD, Osaka-shi (JP)

(21) Appl. No.: 10/716,419

(22) Filed: Nov. 20, 2003

(30) Foreign Application Priority Data
Nov. 21, 2002 (JP) P2002-338119
Nov. 21, 2002 (JP) P2002-338198

(51) Int. Cl. H01R 27/00

(52) U.S. Cl. 439/217

(57) ABSTRACT

A vehicle-installed relay box is for installing a relay used for controlling power supply to a load in a vehicle-installed system provided with different specifications, the relay being configured to different specifications using one or more relay elements in combination in accordance with one type of specification selected from among the different specifications of the vehicle-installed system. The vehicle-installed relay box includes: a plurality of terminals; an installation socket configured to install the relay element; and a wiring configured to connect the relay element installed in the installation socket and the terminals. The installation socket is further configured to be installed a different relay element in accordance with the selected type of specification from among the different specifications of the vehicle-installed system.

### BACKGROUND OF THE INVENTION

1. Field of the Invention

The present invention relates to a vehicle-installed relay box for installing a plurality of relays used for controlling power supply to loads in various vehicle-installed systems.

2. Description of the Related Art

Usually, as each relay used for controlling power supply to loads in various vehicle-installed systems installed in a vehicle-installed relay box, the relay of the optimum specifications (namely, an optimum combination of one or more relay elements) is selected in accordance with the vehicle-installed system to which the controlling power supply is applied.

However, some vehicle-installed systems have the specifications different in accordance with the areas where the vehicle is to be used, and the specifications of the relay used for controlling power supply to load in such a vehicle-installed system need to be changed so as to match the specifications of the vehicle-installed system to which the controlling power supply is applied.

Thus, usually the vehicle-installed relay box is formed with installation sockets for the specifications corresponding to a plurality of areas where the vehicle is to be used assumed for each installed relay (more particularly, installation sockets of the relay elements for implementing the specifications) so that the relay can be installed in accordance with the specifications matching the specifications of the vehicle-installed system to which the controlling power supply is applied if any of the areas where the vehicle is to be used is selected.

In a vehicle-installed relay box in a related art, the installation socket of each of the relay elements for implementing the specifications of the relay is formed as the installation socket dedicated to the relay element.

FIG. 11 is a schematic drawing of an example of such a vehicle-installed relay box in the related art. A vehicle-installed relay box 100 in FIG. 11 includes, for example, a relay 5 used for controlling power supply to a fan F in a fan control system 3 different in specifications responsive to areas where the vehicle is to be used A and B as in FIGS. 13 and 14 and relays 9 and 11 used for controlling power supply to a motor M and a solenoid S of an ABS actuator in an ABS control system 7 different in specifications responsive to areas where the vehicle is to be used A and B as in FIGS. 15 and 15 with different specifications 5A (5B), 9A (9B), and 11A (11B) so as to match specifications 3A (3B) and 7A (7B) of the vehicle-installed systems 3 and 7 to which the controlling power supply is applied in accordance with the area A (B) selected from the areas where the vehicle is to be used A and B.

In the embodiment, the specifications 5A of the relay 5 used for the specifications (fan series parallel control specifications) 3A of the fan control system 3 for the area A are made up of three relay elements (here, mechanical relays and so forth on) 5A₁, 5A₂, and 5A₃ in combination, for example, as in FIG. 13. The specifications 5B of the relay 5 used for the specifications (fan number-of-revolutions control specifications) 3B of the fan control system 3 for the area B are made up of two relay elements 5B₁ and 5B₂ in parallel combination, for example, as in FIG. 14. The specifications 9A (11A) of the relay 9 (11) used for the specifications 7A of the ABS control system 7 for the area A are implemented as one relay element 9₁ (11₁), for example, as in FIG. 15. The specifications 9B (11B) of the relay 9 (11) used for the specifications 7B of the ABS control system 7 for the area B are made up of two relay elements 9₁ and 9₂ (11₁ and 11₂) in parallel combination with relay element 9₂ (11₂) optionally added to the specifications 9A (11A) in FIG. 15, for example, as in FIG. 16.

The vehicle-installed relay box 100 is formed with installation sockets W1, W2, W3; W4, W5; W6; W6, W7; W8; W8, W9 dedicated to the relay elements 5A₁, 5A₂, 5A₃; 5B₁, 5B₂; 9₁; 9₁, 9₂; 11₁; 11₁, 11₂ for implementing the specifications 5A; 5B; 9A; 9B; 11A; 11B of the relays 5, 9, and 11, as in FIG. 11. The installation socket of the specifications 9B (11B) of the relay 9 (11) is formed by adding the installation socket W7 (W9) dedicated to the relay element 9₂ (11₂) as optional addition to the installation socket W6 (W8) of the specifications 9A (11A).

If the area A (B) is selected, the relay elements 5A₁, 5A₂, 5A₃, 9₁, 11₁ (5B₁, 5B₂, 9₁, 9₂, 11₁, 11₂) for implementing the specifications 5A, 9A, 11A (5B, 9B, 11B) corresponding to the area A (B) of the relays 5, 9, and 11 are installed in the installation sockets W1 to W3, W7, and W9 (W4 to W9), as in FIG. 11 (FIG. 12). The remaining installation sockets W4, W5, W6, and W8 (W1 to W3) corresponding to the area B (A) become unassigned (unassigned installation socket is marked with X).

In the vehicle-installed relay box 100 in the related art, the installation sockets W1 to W9 of the relay elements 5A₁, 5A₂, 5A₃, 5B₁, 5B₂, 9₁, 9₂, 11₁, and 11₂ for implementing the specifications 5A, 5B, 9A, 9B, 11A, and 11B of the relays 5, 9, and 11 are formed in a one-to-one correspondence with the relay elements, as described above. Thus, it is necessary to form as many relay element installation sockets W1 to W9 as the number of the relay elements 5A₁, 5A₂, 5A₃, 5B₁, 5B₂, 9₁, 9₂, 11₁, and 11₂ for implementing the specifications 5A, 5B, 9A, 9B, 11A, and 11B of the relays 5, 9, and 11, and the vehicle-installed relay box 100 has the disadvantage in that it is upsized.

Moreover, if the area A (B) is selected, the installation sockets W4, W5, W6, and W8 (W1 to W3) of the relay elements 5B₁, 5B₂, 9₂, and 11₂ (5A₁, 5A₂, and 5A₃) for implementing the specifications 5B, 9B, and 11B (5A) corresponding to the unselected area B (A) become unassigned, and the vehicle-installed relay box 100 has the disadvantage in that the space is wasted.

On the other hand, different specifications are provided for some vehicle-installed systems, and the specifications of the relay used for controlling power supply to load in such a vehicle-installed system need to be changed in accordance with the specifications of the selected vehicle-installed system.

Thus, usually the vehicle-installed relay box is formed with installation sockets for the specifications corresponding to a plurality of specifications provided for the vehicle-installed system to which the controlling power supply is applied for the relay (more particularly, installation sockets of the mechanical relays for implementing the specifications) so that the relay can be installed in the specifications matching the selected specifications of the vehicle-installed system to which the controlling power supply is applied if which of the specifications are selected.

Generally, the mechanical relays for implementing the specifications of the relay differ in outer shape and outer dimensions in accordance with the specifications of the mechanical relays (rated current having the effect on limitation caused by heat generation, rush current resistance having the effect on the contact life, and the like), and the specifications of the mechanical relays differ in accordance with the specifications of the relay implemented as the mechanical relays. Thus, generally the mechanical relays for implementing the specifications of the relay differ in outer shape and outer dimensions for each type of specifications of the relay.

Thus, in a vehicle-installed relay box in a related art, the installation socket of each of the mechanical relays for implementing the specifications of the relay is formed separately for each type of specifications of the relay. If another relay for applying controlling power supply to another vehicle-installed system is also installed at the same time, the installation sockets of the mechanical relays for implementing the specifications of the relay are formed separately for each relay.

FIG. 17 is a schematic drawing of an example of such a vehicle-installed relay box in the related art. A vehicle-installed relay box 100 in FIG. 17 includes, for example, a relay 5 used for controlling power supply to a fan F in a fan control system 3 provided with two types of specifications of fan number-of-revolutions control (fan series parallel control specifications 3A in FIG. 18 and fan number-of-revolutions control specifications 3B in FIG. 8) is installed as different specifications 5A or 5B in accordance with the specifications selected from the specifications 3A and 3B of the vehicle-installed system 3, and also includes a relay 9 used for controlling power supply to a lamp R in a light control system 7 provided with two types of specifications (normal control specifications 7A in FIG. 9 and HID control specifications 7B in FIG. 10) is installed as different specifications 9A or 9B in accordance with the specifications selected from the specifications 7A and 7B of the vehicle-installed system 7.

In the embodiment, the specifications 5A of the relay 5 used for the specifications 3A of the fan control system 3 are made up of three mechanical relays 5A₁, 5A₂, and 5A₃ in combination, for example, as in FIG. 8. The specifications 5B of the relay 5 used for the specifications 3B of the fan control system 3 are implemented as one mechanical relay 5B₁, for example, as in FIG. 8. The mechanical relay 5B₁ perform controlling power supply to two fans and thus a larger one than the mechanical relay 5A₁, 5A₂, or 5A₃ is used. The specifications 9A (9B) of the relay 9 used for the specifications 7A (7B) of the light control system 7 are implemented as one mechanical relay 9A1 (9B1), for example, as in FIG. 9 (FIG. 10). Since the rush current of the lamp R subjected to HID control is larger than the rush current of the lamp R not subjected to HID control, as the mechanical relay 9B1 for also performing controlling power supply to the lamp R subjected to HID control, a mechanical relay excellent in rush current resistance as compared with the mechanical relay 9A1 for performing only controlling power supply to the lamp R not subjected to HID control (namely, a mechanical relay different from the mechanical relay 9A₁, in outer shape and outer dimensions) is used.

The vehicle-installed relay box 200 is formed separately with installation sockets W1, W2, and W3 (W4, W5, and W6) of the mechanical relays 5A₁, 5A₂, and 5A₃ (5B₁, 9A₁, and 9B₁) for implementing the specifications 5A (5B, 9A, 9B) for each type of the specifications 5A, 5B, 9A, and 9B of the relays 5 and 9, as in FIG. 17.

In the vehicle-installed relay box 200, if the specifications 3A (3B) are selected for the specifications of the fan control system 3, the mechanical relays 5A₁, 5A₂, and 5A₃ (5B₁) for implementing the specifications 5A (5B) of the relay 5 used in the specifications 3A (3B) are installed in the installation sockets W1 to W3 (W4), as in FIG. 17 (FIG. 18). The installation socket W4 (W1 to W3) of the mechanical relay 5B1 (5A₁, 5A₂, and 5A₃) for implementing the specifications 5B (5A) of the relay 5 used in the specifications 3B (3A) not selected becomes unassigned (unassigned installation socket is marked with X).

Likewise, if the specifications 7A (7B) are selected for the specifications of the lamp control system 7, the mechanical relay 9A₁ (9B₁) for implementing the specifications 9A (9B) of the relay 9 used in the specifications 7A (7B) is installed in the installation socket W5 (W6), as in FIG. 17 (FIG. 18). The installation socket W6 (W5) of the mechanical relay 9B₁ (9A₁) for implementing the specifications 9B (9A) of the relay 9 used in the unselected specifications 7B (7A) of the lamp control system 7 becomes unassigned.

In the vehicle-installed relay box 200 in the related art, the installation sockets W1 to W6 of the mechanical relays 5A₁, 5A₂, 5A₃, 5B₁, 9A₁, and 9B₁ for implementing the specifications 5A, 5B, 9A, and 9B of the relays 5 and 9 are formed separately, as described above. Thus, it is necessary to form as many installation sockets W1 to W6 as the number of the mechanical relays 5A₁, 5A₂, 5A₃, 5B₁, and 5B₂ for implementing the specifications 5A, 5B, 9A, and 9B of the relays 5 and 9, and the vehicle-installed relay box 200 has the disadvantage in that it is upsized.

Further, in the vehicle-installed relay box 200 in the related art, as described above, if the specifications 5A, 9A (5B, 9B) of the relay 5, 9 are selected, the installation socket W4, W6 (W1 to W3, W5) of the mechanical relay 5B₁, 9B₁ (5A₁, 5A₂, 5A₃, 9A₁) for implementing the specifications 5B, 9B (5A, 9A) not selected becomes unassigned, and the vehicle-installed relay box 100 has the disadvantage in that the space is wasted.

### SUMMARY OF THE INVENTION

It is therefore an object of the invention to provide a vehicle-installed relay box that can decrease waste of space and can be miniaturized.

In order to achieve the object, according to one aspect of the invention, there is provided a vehicle-installed relay box for installing a relay used for controlling power supply to a load in a vehicle-installed system provided with different specifications, the relay being configured to different specifications using one or more relay elements in combination in accordance with one type of specification selected from among the different specifications of the vehicle-installed system, the vehicle-installed relay box including: a plurality of terminals; an installation socket configured to install the relay element; and a wiring configured to connect the relay element installed in the installation socket and the terminals, wherein the installation socket is further configured to be installed a different relay element in accordance with the selected type of specification from among the different specifications of the vehicle-installed system.

### BRIEF DESCRIPTION OF THE DRAWINGS

The objects and advantages of the present invention will become more apparent by describing preferred embodiments thereof in detail with reference to the accompanying drawings, wherein:

FIG. 1 is a schematic drawing of a vehicle-installed relay box according to a first embodiment of the invention and is a drawing to show the relay installation state when one area where the vehicle is to be used in the vehicle-installed relay box is selected;

FIG. 2 is a drawing to show the relay installation state when another area where the vehicle is to be used in the vehicle-installed relay box shown in FIG. 1 is selected;

FIG. 3 is a plan view of an example of the configuration of the main part of the vehicle-installed relay box shown in FIG. 1;

FIG. 4 is a schematic drawing of a vehicle-installed relay box according to a second embodiment of the invention and is a drawing to show an example of the relay installation state in the vehicle-installed relay box;

FIG. 5 is a drawing to show another example of the relay installation state in the vehicle-installed relay box shown in FIG. 4;

FIG. 6 is a plan view of an example of the configuration of the main part of the vehicle-installed relay box shown in FIG. 4;

FIG. 7 is a drawing to show an example of the configuration of the specifications of a fan control system;

FIG. 8 is a drawing to show an example of the configuration of different specifications of the fan control system;

FIG. 9 is a drawing to show an example of the configuration of the specifications of a light control system;

FIG. 10 is a drawing to show an example of the configuration of different specifications of the light control system;

FIG. 11 is a schematic drawing of a vehicle-installed relay box in a related art and is a drawing to show the relay installation state when one area where the vehicle is to be used in the vehicle-installed relay box is selected;

FIG. 12 is a drawing to show the relay installation state when another area where the vehicle is to be used in the vehicle-installed relay box shown in FIG. 11 is selected;

FIG. 13 is a drawing to show an example of the configuration of the specifications of a fan control system for area A;

FIG. 14 is a drawing to show an example of the configuration of the specifications of the fan control system for area B;

FIG. 15 is a drawing to show an example of the configuration of the specifications of an ABS control system for area A; and

FIG. 16 is a drawing to show an example of the configuration of the specifications of the ABS control system for area B.

FIG. 17 is a schematic drawing of a vehicle-installed relay box in a related art and is a drawing to show an example of the relay installation state in the vehicle-installed relay box; and

FIG. 18 is a drawing to show another example of the relay installation state in the vehicle-installed relay box shown in FIG. 17.

### DETAILED DESCRIPTION OF THE PREFERRED EMBODIMENTS

Referring now to the accompanying drawings, a description will be given in detail of preferred embodiments of the invention.

First Embodiment

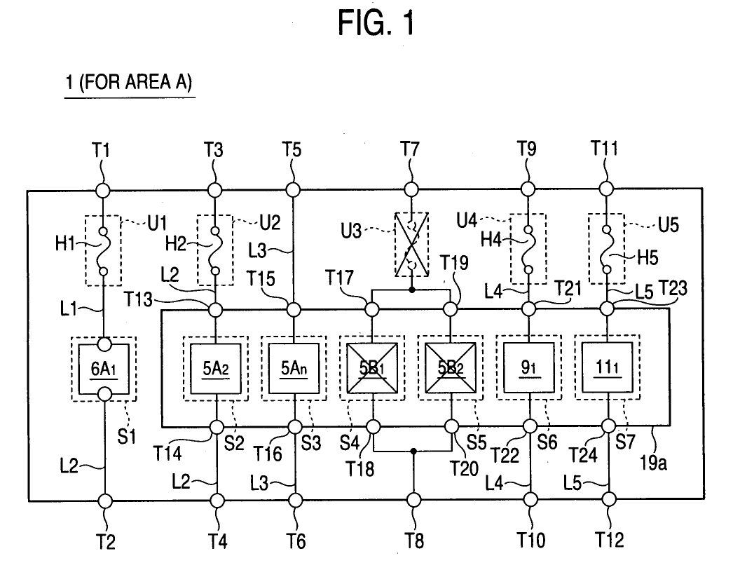

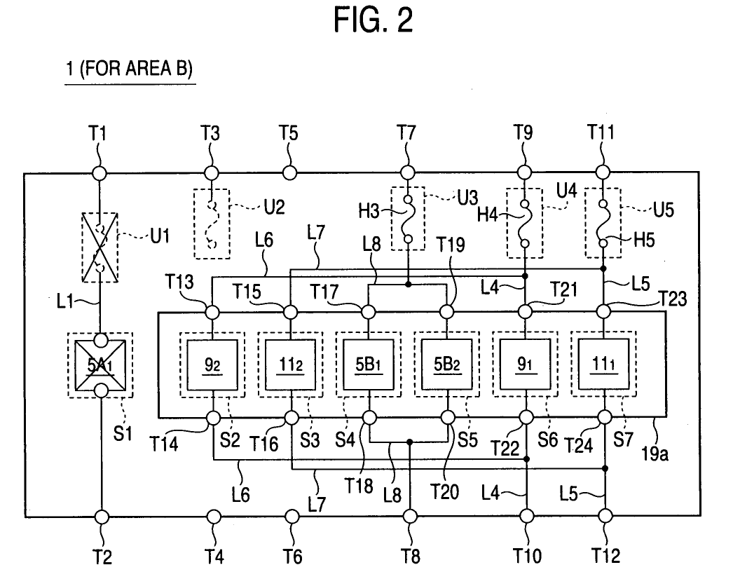

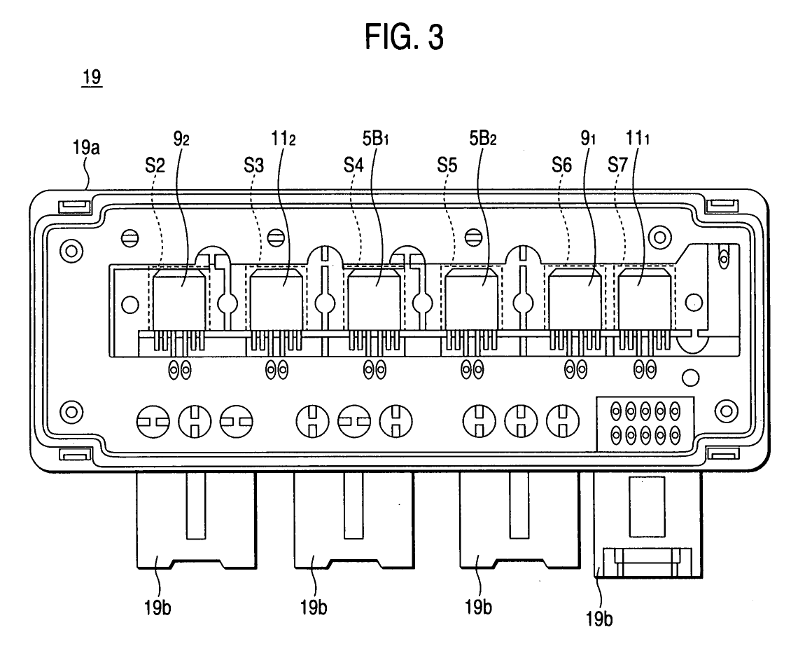

FIG. 1 is a schematic drawing of a vehicle-installed relay box according to a first embodiment of the invention and is a drawing to show the relay installation state when one area where the vehicle is to be used in the vehicle-installed relay box is selected. FIG. 2 is a drawing to show the relay installation state when another area where the vehicle is to be used in the vehicle-installed relay box in FIG. 1 is selected. FIG. 3 is a plan view of an example of the configuration of the main part of the vehicle-installed relay box in FIG. 1.

A vehicle-installed relay box 1 according to the first embodiment includes a plurality of relays used for controlling power supply to loads in various vehicle-installed systems having the specifications different in accordance with areas where the vehicle is to be used, each of the relays being configured to different specifications using one or more relay elements in combination so as to match the specifications of the vehicle-installed system to which the controlling power supply is applied in accordance with one area selected from among assumed areas where the vehicle is to be used. The vehicle-installed relay box 1 also includes a plurality of fuses used with the various vehicle-installed systems.

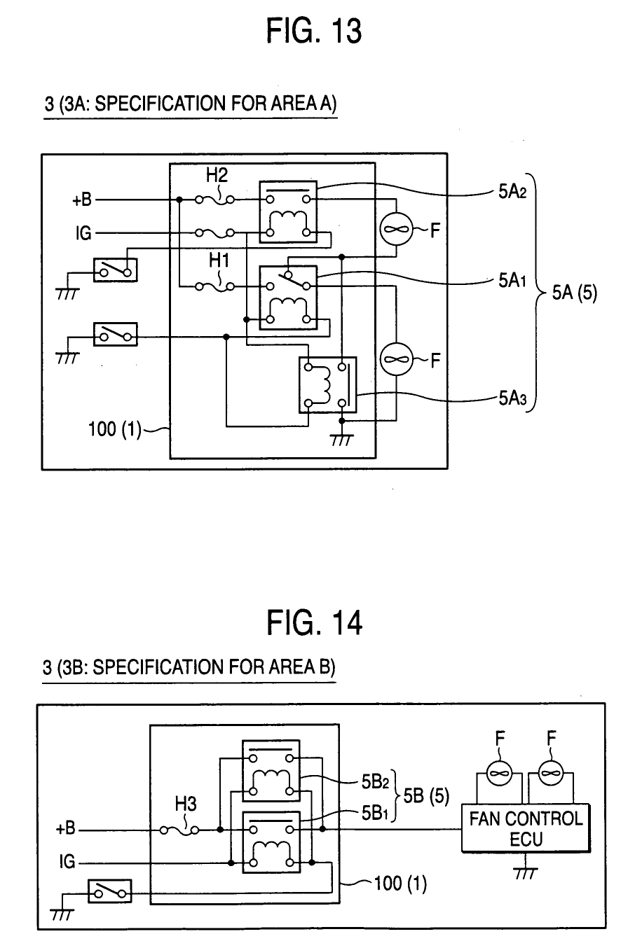

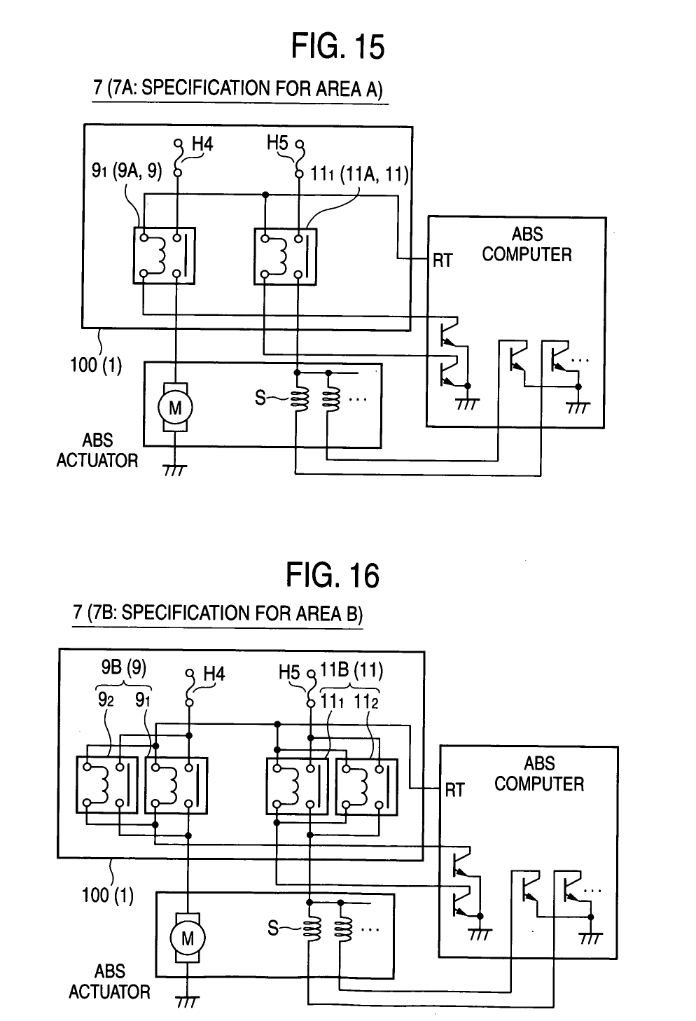

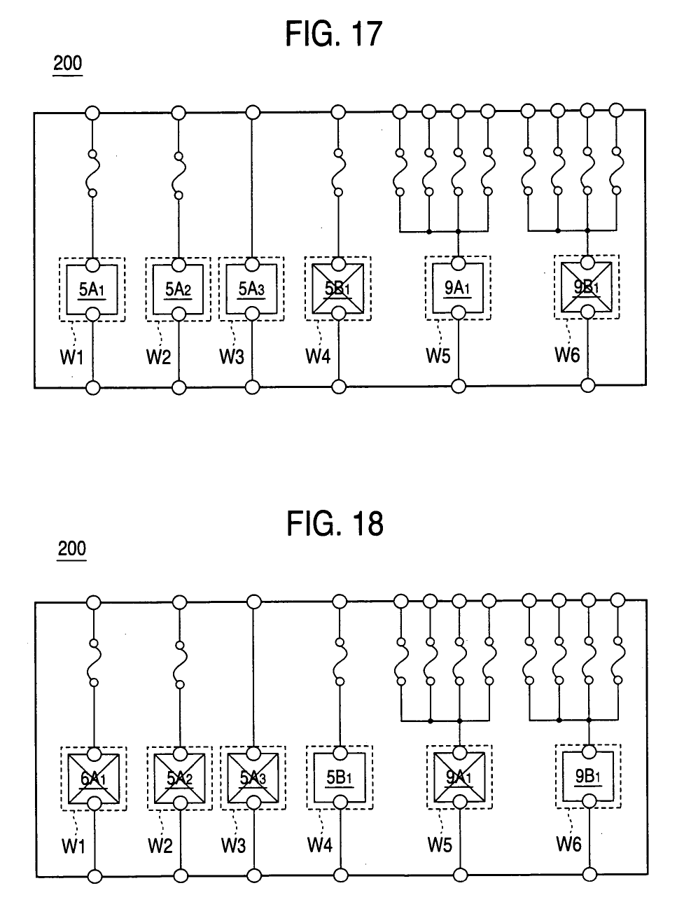

In the embodiment, the controlling power supply is applied to a fan control system 3 (see FIGS. 13 and 14) and an ABS control system 7 (see FIGS. 15 and 16) having different specifications in accordance with area A, B, for example, as in the related art example, as the above-mentioned various vehicle-installed systems. In the embodiment, as the areas where the vehicle is to be used mentioned above, areas where the vehicle is to be used A and B are assumed, for example, as in the related art example.

In the embodiment, specifications 5A, 5B, 9A, 9B, 11A, 11B corresponding to each area A, B, of each of relays 5, 9, and 11 used for the controlling power supply to loads F, M, and S of the vehicle-installed systems 3 and 7 are implemented as a combination of one or more relay elements standardized to the same outer shape and the same outer dimensions unlike those in the related art example. The relay elements are implemented as semiconductor relays, for example, so that they are standardized to the same outer shape and the same outer dimensions.

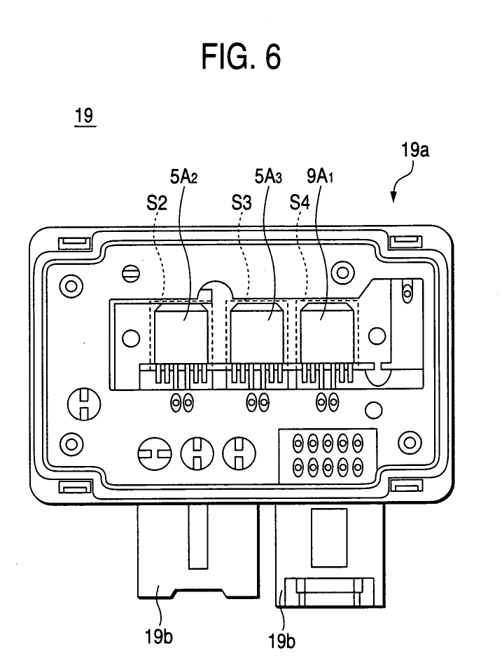

More particularly, the specifications 5A corresponding to the area A, of the relay 5 used with the fan control system 3 are implemented as only a-contact mechanical relays 5A2 and 5A3 in the specifications 5A in FIG. 6, for example, are replaced with semiconductor relays (semiconductor relays 5A₂ and 5A₃) with a so-called c-contact mechanical relay 5A₁ intact, for example, (namely, the specifications 5A are implemented as a combination of one mechanical relay 5A₁ and two semiconductor relays 5A₂ and 5A₃).

The specifications 5B corresponding to the area B, of the relay 5 used with the fan control system 3 are implemented as mechanical relays 5B₁ and 5B₂ in the specifications 5B in FIG. 14, for example, are replaced with semiconductor relays (semiconductor relays 5B₁ and 5B₂) (namely, the specifications 5B are implemented as a combination of two semiconductor relays 5B₁ and 5B₂).

The specifications 9A (11A) corresponding to the area A, of the relay 9 (11) used with the ABS control system 7 are implemented as mechanical relay 9₁ (11₁) in the specifications 9A (11A) in FIG. 15, for example, is replaced with a semiconductor relay (semiconductor relay 9₁ (11₁)) (namely, the specifications 9A (11A) are implemented as one semiconductor relay 9₁ (11₁)).

The specifications 9B (11B) corresponding to the area B, of the relay 9 (11) used with the ABS control system 7 are implemented as mechanical relays 9₁ and 9₂ (11₁ and 11₂) in the specifications 9B (11B) in FIG. 16, for example, are replaced with semiconductor relays (semiconductor relays 9₁ and 9₂ (11₁ and 11₂)) (namely, the specifications 9B (11B) are implemented as two semiconductor relays 9₁ and 9₂ (11₁ and 11₂)).

The vehicle-installed relay box 1 is formed inside with installation sockets S1 to S7 for installing relay elements 5A₁, 5A₂, 5A₃, 5B₁, 5B₂, 9₁, 9₂, 11₁, 11₂ for implementing the specifications 5A, 5B, 9A, 9B, 11A, 11B of the relays 5, 9, and 11 used with the vehicle-installed systems 3 and 7, and installation sockets U1 to U5 for installing a plurality of fuses H1 to H5 used with the vehicle-installed systems 3 and 7, as in FIG. 1. The vehicle-installed relay box 1 also includes wirings L1 to L8 for connecting the relay elements 5A₁, 5A₂, 5A₃, 5B₁, 5B₂, 9₁, 9₂, 11₁, 11₂ and the fuses H1 to H5 in the required connection relationship and connection terminals T1 to T12 of the wirings L1 to L8 and wirings of the vehicle-installed systems 3 and 7 (not shown).

In the embodiment, the installation socket of the mechanical relay 5A₁ is formed by the installation socket S1. The installation sockets of the semiconductor relays 5A₂, 5A₃, 5B₁, 5B₂, 9₁, 9₂, 11₁, and 11₂ are formed by the installation sockets S2 to S7.

More particularly, the installation sockets of the semiconductor relays 5A₂ and 5A₃ (5B₁ and 5B₂) for implementing the specifications 5A (5B) of the relay 5 corresponding to the area A (B) are formed by the installation sockets S2 and S3 (S4 and S5). The installation socket of the semiconductor relay 9₁, 11₁ (9₁, 9₂, 11₁, 11₂) for implementing the specifications 9A, 11A (9B, 11B) of the relay 9, 11 corresponding to the area A (B) is formed by the installation socket S6, S7 (S6, S2, S8, S3). That is, the installation sockets S2 and S3 of the semiconductor relays 5A₂ and 5A₃ for implementing the specifications 5A of the relay 5 also serve as the installation sockets of the semiconductor relays 9₂ and 11₂ for implementing the specifications 9B and 11B of the relays 9 and 11.

The vehicle-installed relay box 1 includes a semiconductor module 19, and the semiconductor relay installation sockets S2 to S7 are formed in the semiconductor module 19. For example, as shown in FIG. 3, the semiconductor module 19 is formed in a case 19a with a predetermined number of (here, for example, six) semiconductor relay installation sockets S2 to S7, and includes the semiconductor relays installed in the installation sockets S2 to S7 (in FIG. 3, for example, the semiconductor relays 5B₁, 5B₂, 9₁, 9₂, 11₁, 11₂ for implementing the specifications of the relays 5, 9, and 11 corresponding to the area B) and connectors 19b housing terminals T13 to T24 (see FIG. 1) electrically connected to input/output terminals of the semiconductor relays installed in the installation sockets S2 to S7. The wirings L1 to L8 are connected to the terminals T13 to T24 in the connectors 19b and thus are connected to the semiconductor relays installed in the installation sockets S2 to S7.

More particularly, for example, the case 19a is shaped like a slim box with the top opened, and the predetermined number of semiconductor relay installation sockets S2 to S7 are formed so that they are laid out in a predetermined arrangement (in FIG. 3, a row) on the bottom of the case 19a. The connectors 19b are disposed like projections on the outer side of the peripheral wall of the case 19a, for example.

As the predetermined number, the largest number of the number of the installation sockets S2, S3, S6, and S7 (S2 to S7) of the semiconductor relays 5A₂, 5A₃, 9₁, and 11₁ (5B₁, 5B₂, 9₁, 9₂, 11₁, and 11₂) actually installed for the assumed area A (B) is adopted.

Next, the installation state of the relays 5, 9, and 11 and the fuses H1 to H5 when the area A or B is selected will be discussed in detail.

When the area A is selected, as in FIG. 1, the relay elements 5A₁, 5A₂, 5A₃, 9₁, and 11₁ for implementing the specifications 5A, 9A, and 11A of the relays 5, 9, and 11 used with the specifications 3A and 7A of the vehicle-installation systems 3 and 7 for the area A are installed in the relay element installation sockets S1, S2, S3, S6, and S7, and the fuses H1, H2, H4, and H5 used with the specifications 3A and 7A of the vehicle-installation systems 3 and 7 for the area A are installed in the fuse installation sockets U1, U2, U4, and U5. In the embodiment, the relay element installation sockets S4 and S5 and the fuse installation socket U3 become unassigned (unassigned installation socket is marked with X).

The wirings L1 to L5 are disposed so that the relay elements 5A₁, 5A₂, 5A₃, 9₁, and 11₁, the fuses H1, H2, H4, and H5, and the terminals T1 to T6 and T9 to T12 are connected in the connection relationship for the area A. In the embodiment, for example, the wiring L1 (L2, L4, L5) is disposed so that the relay element 5A₁ (5A₂, 9₁, 11₁) and the fuse H1 (H2, H4, H5) are connected in series and are connected between the terminals T1 and T2 (T3 and T4, T9 and T10, T11 and T12). The wiring L3 is disposed so that the relay element 5A3 is connected between the terminals T5 and T6. The terminals T7 and T8 not used in the configuration for the area A may not be disposed. The vehicle-installed relay box 1 for the area A is thus configured.

On the other hand, when the area B is selected, as shown in FIG. 2, the relay elements 5B₁, 5B₂, 9₁, 9₂, 11₁, and 11₂ for implementing the specifications 5B, 9B, and 11B of the relays 5, 9, and 11 used with the specifications 3B and 7B of the vehicle-installation systems 3 and 7 for the area B are installed in the relay element installation sockets S2 to S7, and the fuses H3, H4, and H5 used with the specifications 3B and 7B of the vehicle-installation systems 3 and 7 for the area B are installed in the fuse installation sockets U3, U4, and U5. In the embodiment, the relay element installation socket S1 and the fuse installation sockets U1 and U2 become unassigned.

The wirings L6 to L8 are connected so that the relay elements 5B₁, 5B₂, 9₁, 9₂, 11₁, and 11₂, the fuses H3, H4, and H5, and the terminals T7 to T12 are connected in the connection relationship for the area B. In the embodiment, for example, the wiring L6 (L7, L8) is disposed so that the relay elements 9₁ and 9₂ (11₁, and 11₂, 5B₁, and 5B₂) are connected in parallel and the relay elements 9₁ and 9₂ (11₁ and 11₂, 5B₁, and 5B₂) connected in parallel and the fuse H4 (H5, H3) are connected in series and are connected between the terminals T9 and T10 (T11 and T12, T7 and T8). The wiring L3 is disposed so that the relay element 5A₃ is connected between the terminals T5 and T6. The vehicle-installed relay box 1 for the area B is thus configured.

According to the vehicle-installed relay box 1 according to the first embodiment, the installation sockets S1 to S7 of the relay elements 5A₁, 5A₂, 5A₃, 5B₁, 5B₂, 9₁, 9₂, 11₁, and 11₂ for implementing the specifications 5A, 5B, 9A, 9B, 11A, and 11B corresponding to the areas where the vehicle is to be used A and B about the relays 5, 9, and 11 are formed in such a manner that the installation sockets S2 and S3 of the relay elements (for example, the relay elements 5A₂ and 5A₃) for implementing the specifications 5A corresponding to one area A of the areas where the vehicle is to be used A and B assumed for each of the relays 5, 9, and 11 (for example, the relay 5) also serve as the installation sockets of the relay elements (for example, 9₂ and 11₂) for implementing the specifications 9B and 11B corresponding to the other area B of the areas where the vehicle is to be used A and B for other relays (for example, the relays 9 and 11). Thus, the areas where the vehicle is to be used A and B can be covered and unassigned installation sockets of the relay elements 9₂ and 11₂ for implementing the specifications 9B and llB corresponding to the area B unselected for the installed relays 9 and 11 can be decreased and the vehicle-installed relay box can be miniaturized.

Here, specifically the vehicle-installed relay box 100 in the related art example requires the installation sockets W1 to W9 for the nine relay elements; in the embodiment, however, the vehicle-installed relay box 1 of the embodiment needs only the installation sockets S1 to S7 for the seven relay elements to provide a similar vehicle-installed relay box to the vehicle-installed relay box 100, so that waste of the space can be decreased accordingly and the vehicle-installed relay box can be miniaturized.

The relay elements 5A₂, 5A₃, 5B₁, 5B₂, 9₁, 9₂, 11₁, and 11₂ are standardized to the same outer shape and the same outer dimensions, so that the installation socket of one relay element can also be easily used as the installation socket of another.

Since the relay elements 5A₂, 5A₃, 5B₁, 5B₂, 9₁, 9₂, 11₁, and 11₂ are implemented as the semiconductor relays, they can be easily standardized to the same outer shape and the same outer dimensions. Usually, the package sizes (package shapes and sizes) of the semiconductor relays are standardized and the semiconductor relays involve no limitation on the installation socket depending on the outer shape unlike mechanical relays and moreover a large number of manufacturers manufacture the semiconductor relays having various types of performance. Thus, the semiconductor relays are fitted for use for the purpose of standardization of the relay elements 5A₂, 5A₃, 5B₁, 5B₂, 9₁, 9₂, 11₁, and 11₂ to the same outer shape and the same outer dimensions.

Second Embodiment

Hereinafter, a second embodiment of the invention will be described.

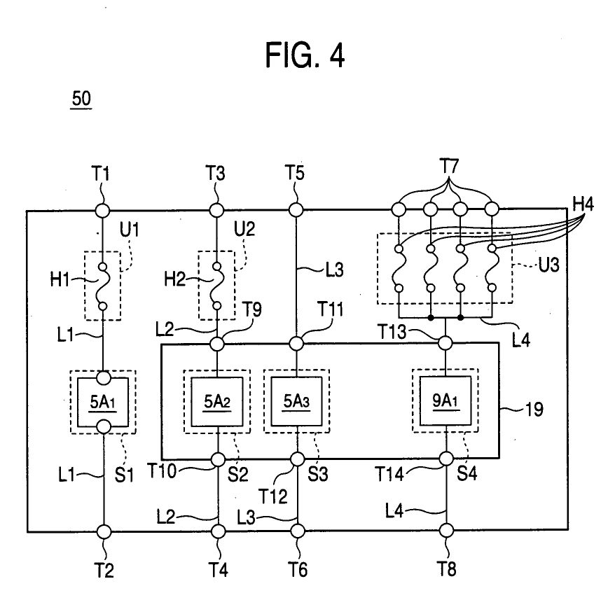

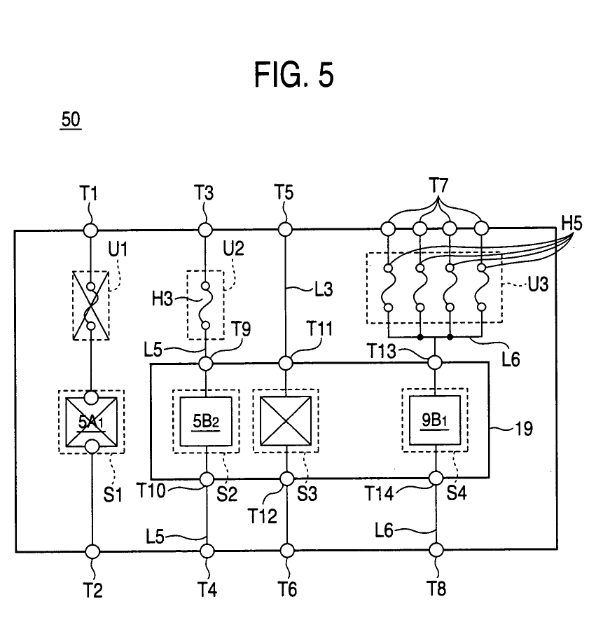

FIG. 4 is a schematic drawing of a vehicle-installed relay box according to the second embodiment of the invention and is a drawing to show an example of the relay installation state in the vehicle-installed relay box. FIG. 5 is a drawing to show another example of the relay installation state in the vehicle-installed relay box in FIG. 4. FIG. 6 is a plan view of an example of the configuration of the main part of the vehicle-installed relay box in FIG. 4.

A vehicle-installed relay box 50 according to the second embodiment includes one or more (here, two) relays used for controlling power supply to loads in vehicle-installed systems each provided with different specifications, each of the relays being configured to different specifications using one or more relay elements in combination in accordance with the specifications selected from among the different specifications of the vehicle-installed system to which the controlling power supply is applied. The vehicle-installed relaybox 50 also includes fuses used with the vehicle-installed systems.

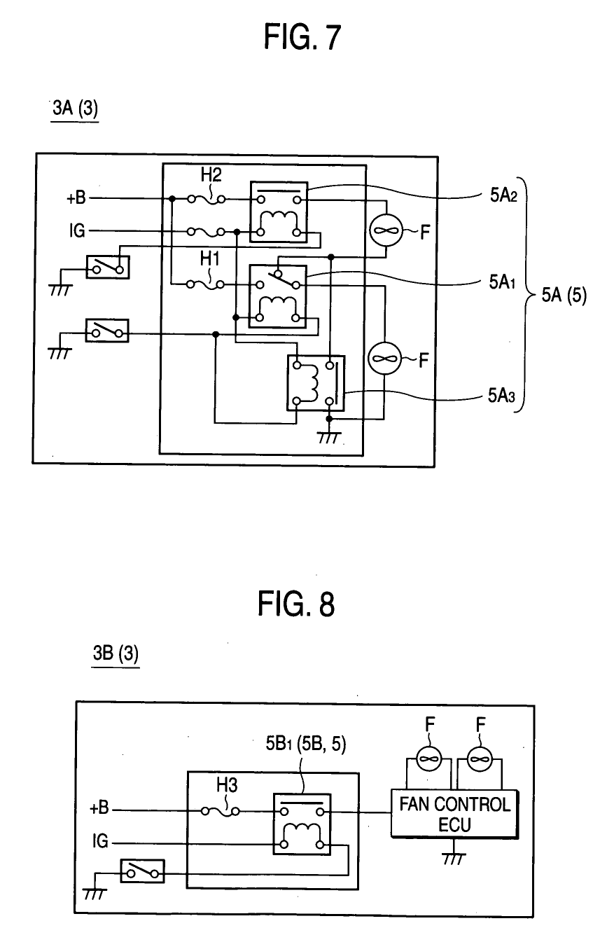

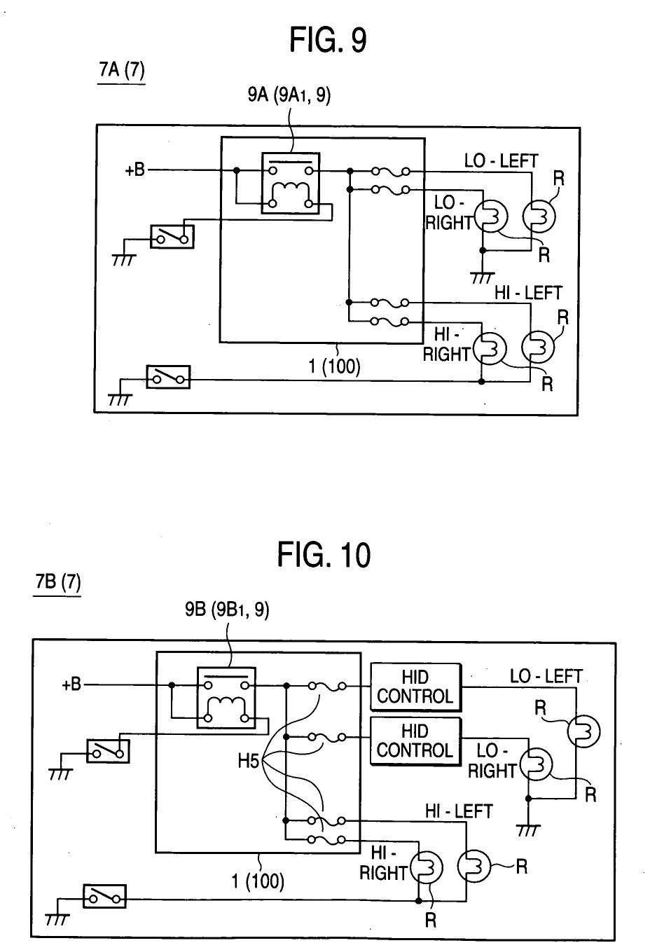

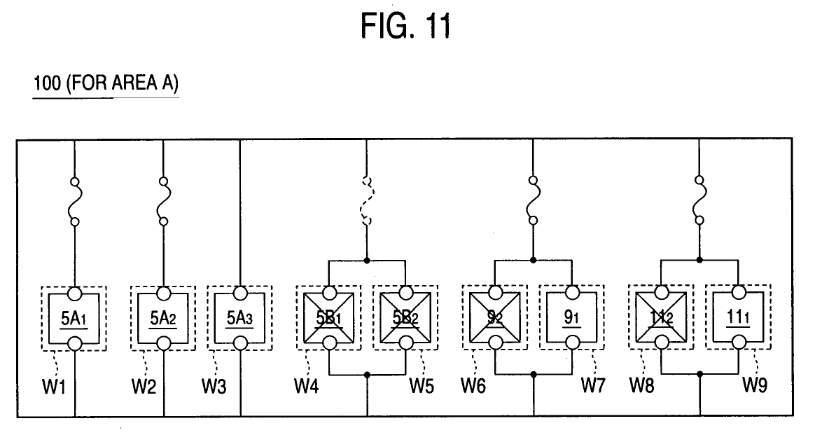

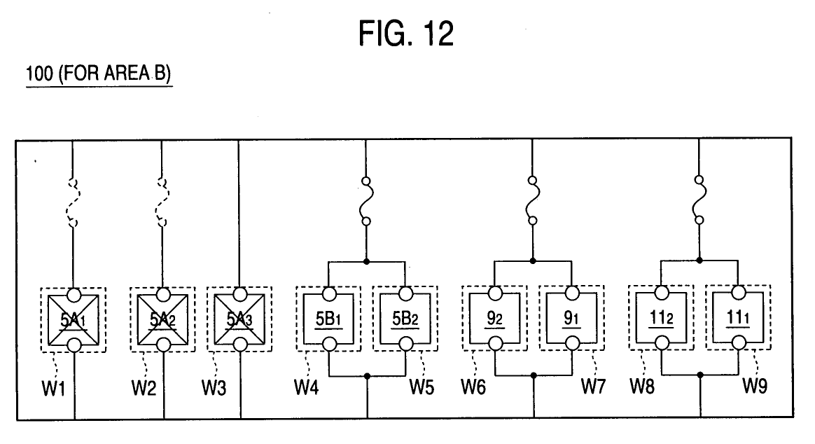

In the embodiment, the controlling power supply is applied to a fan control system 3 provided with two types of specifications (fan series parallel control specifications 3A in FIG. 7 and fan number-of-revolutions control specifications 3B in FIG. 8) and a light control system 7 provided with two types of specifications (normal control specifications 7A in FIG. 9 and HID control specifications 7B in FIG. 10) as in the related art example, as the above-mentioned vehicle-installed systems.

In the embodiment, specifications 5A, 5B, 9A, 9B of each of relays 5 and 9 used for the controlling power supply to loads F and R of the vehicle-installed systems 3 and 7 are implemented as a combination of one or more relay elements standardized to the same outer shape and the same outer dimensions unlike those in the related art example. The relay elements are implemented as semiconductor relays, for example, so that they are standardized to the same outer shape and the same outer dimensions.

More particularly, the specifications 5A of the relay 5 used with the specifications 3A of the fan control system 3 are implemented as only a-contact mechanical relays 5A₂ and 5A₃ in the specifications 5A in FIG. 7, for example, are replaced with semiconductor relays (semiconductor relays 5A₂ and 5A₃) with c-contact mechanical relay 5A₁ intact, for example, (namely, the specifications 5A are implemented as a combination of one mechanical relay 5A₁, and two semiconductor relays 5A₂ and 5A₃) The specifications 5B of the relay 5 used with the specifications 3B of the fan control system 3 are implemented as a mechanical relay 5B1 in the specifications 5B in FIG. 8, for example, is replaced with a semiconductor relay (semiconductor relay 5B₁) (namely, the specifications 5B are implemented as one semiconductor relays 5B₁).

The specifications 9A (9B) of the relay 9 used in the specifications 7A (7B) of the light control system 7 are implemented as mechanical relay 9A₁ (9B₁) in the specifications 9A (9B) in FIG. 9 (FIG. 10) , for example, is replaced with a semiconductor relay (semiconductor relay 9A₁ (9B₁)) (namely, the specifications 9A (9B) are implemented as one semiconductor relay 9A₁ (9B₁) The vehicle-installed relay box 50 is formed inside with installation sockets S1 to S4 for installing relay elements 5A₁, 5A₂, 5A₃, 5B₁, 9A₁, 9B₁ for implementing the specifications 5A, 5B, 9A, 9B of the relays 5 and 9 used with the vehicle-installed systems 3 and 7, and installation sockets U1 to U3 for installing fuses H1 to H5 used with the vehicle-installed systems 3 and 7, as in FIG. 4. The vehicle-installed relay box 50 also includes wirings L1 to L6 for connecting the relay elements 5A₁, 5A₂, 5A₃, 5B₁, 9A₁, 9B₁ and the fuses H1 to H5 in the required connection relationship and connection terminals T1 to T8 of the wirings L1 to L6 and wirings of the vehicle-installed systems 3 and 7 (not shown).

In the embodiment, the installation socket of the mechanical relay 5A₁ is formed by the installation socket S1. The installation sockets of the semiconductor relays 5A₂, 5A₃, 5B₁, 9A₁, and 9B₁ are formed by the installation sockets S2 to S4.

More particularly, the installation sockets of the semiconductor relays 5A₂ and 5A₃ (5B₁) for implementing the specifications 5A (5B) of the relay 5 are formed by the installation sockets S2 and S3 (S2). That is, the installation socket S2 of the semiconductor relay 5A₂ for implementing the specifications 5A of the relay 5 also serve as the installation socket of the semiconductor relay 5B1 for implementing the specifications 5B of the relay 5. The installation socket of the semiconductor relay 9A₁ (9B₁) for implementing the specifications 9A (9B) of the relay 9 is formed by the installation socket S4 (S4) That is, the installation socket S4 of the semiconductor relay 9A₁ for implementing the specifications 9A of the relay 9 also serve as the installation socket of the semiconductor relay 9A₁ for implementing the specifications 9B of the relay 9.

The vehicle-installed relay box 50 includes a semiconductor module 19, and the semiconductor relay installation sockets S2 to S4 are formed in the semiconductor module 19.

For example, as shown in FIG. 6, the semiconductor module 19 is formed in a case 19a with a predetermined number of (here, for example, three) semiconductor relay installation sockets S2 to S4, and includes the semiconductor relays installed in the installation sockets S2 to S4 (in FIG. 6, for example, the semiconductor relays 5A₂, 5A₃, and 9A₁) and connectors 19b housing terminals T9 to T14 (see FIG. 4) electrically connected to input/output terminals of the semiconductor relays installed in the installation sockets S2 to S4. The wirings L1 to L6 are connected to the terminals T9 to T14 in the connectors 19b and thus are connected to the semiconductor relays installed in the installation sockets S2 to S4.

More particularly, for example, the case 19a is shaped like a slim box with the top opened, and the predetermined number of semiconductor relay installation sockets S2 to S4 are formed so that they are laid out in a predetermined arrangement (in FIG. 6, a row) on the bottom of the case 19a. The connectors 19b are disposed like projections on the outer side of the peripheral wall of the case 19a, for example.

As the predetermined number, the sum total of the number of the relay elements (here, three) for the specifications using the largest number of relay elements, of the specifications 5A and 5B of the relay 5 (here, 5A) and the number of the relay elements (here, one) for the specifications using the largest number of relay elements, of the specifications 9A and 9B of the relay 9 (here, 9A, 9B) is adopted.

Next, the installation state of the relays 5 and 9 and the fuses H1 to H5 is selected will be discussed in detail.

To begin with, when the specifications 3A are selected as the specifications of the fan control system 3, as in FIG. 4, the relay elements 5A₁, 5A₂, and 5A₃ for implementing the specifications 5A of the relay 5 used with the specifications 3A are installed in the relay element installation sockets W1 to W3, and the fuses H1 and H2 used with the specifications 3A are installed in the fuse installation sockets U1 and U2.

The wirings L1 to L3 are disposed so that the relay elements 5A₁, 5A₂, and 5A₃, the fuses H1 and H2, and the terminals T1 to T6 are connected in the required connection relationship. In the embodiment, for example, the wiring L1 (L2) is disposed so that the relay element 5A₁ (5A₂) and the fuse H1 (H2) are connected in series and are connected between the terminals T1 and T2 (T3 and T4). The wiring L3 is disposed so that the relay element 5A₃ is connected between the terminals T5 and T6. The specifications 5A of the relay 5 and the fuses H1 and H2 used with the specifications 3A of the fan control system 3 are thus installed.

On the other hand, when the specifications 3B are selected as the specifications of the fan control system 3, as in FIG. 5, the relay element 5B₁ for implementing the specifications 5B of the relay 5 used with the specifications 3B is installed in the relay element installation socket W2, and the fuse H3 used with the specifications 3B is installed in the fuse installation socket U2. In the embodiment, the installation sockets S1, S3, and U1 become unassigned (unassigned installation socket is marked with X).

The wiring L5 is connected so that the relay element 5B₁, the fuse H3, and the terminals T3 and T4 are connected in the required connection relationship. In the embodiment, for example, the wiring L5 is disposed so that the relay element 5B₁ and the fuse H3 are connected in series and are connected between the terminals T3 and T4. The terminals T1, T2, T5, and T6 not used in the specifications 3B may not be disposed. The specifications 5B of the relay 5 and the fuse H3 used with the specifications 3B of the fan control system 3 are thus installed.

Likewise, when the specifications 7A (7B) are selected as the specifications of the lamp control system 7, as in FIG. 4 (FIG. 5), the relay element 9A₁ (9B₁) for implementing the specifications 9A (9B) of the relay 9 used with the specifications 7A (7B) is installed in the relay element installation socket W4, and the fuse H4 (H5) used with the specifications 7A (7B) is installed in the fuse installation socket U3.

The wiring L4 (L6) is disposed so that the relay element 9A₁ (9B₁), the fuse H4 (H5), and the terminals T7 and T8 are connected in the required connection relationship. In the embodiment, for example, the wiring L4 (L6) is disposed so that the fuse H4 (H5) is connected at one end to the terminal T7 and at an opposite end to the terminal T13 in common and the terminals T8 and T14 are connected. The specifications 9A (9B) of the relay 9 and the fuse H3 (H5) used with the specifications 7A (7B) of the lamp control system 7 are thus installed. According to the described vehicle-installed relay box 1, the installation sockets S1 to S3 (S4) of the relay elements 5A₁, 5A₂, 5A₃, and 5B₁ (9A₁, 9B₁) for implementing the specifications 5A, 5B (9A, 9B) for each type of different specifications 3A and 3B (7A and 7B) provided for the vehicle-installed system 3 (7) about the relay 5 (9) are formed in such a manner that the installation socket S2 (S4) of the relay element 5A₂ (9A₁) for implementing the specifications 5A (9A) for the specifications 3A (7A) of one type of different specifications 3A and 3B (7A and 7B) provided for the vehicle-installed system 3 (7) to which the controlling power supply s applied about the relay 5 (9) also serves as the installation socket of the relay element 5A₁ (9B₁) for implementing the specifications 5B (9B) for the specifications 3B (7B) of another type of different specifications 3A and 3B (7A and 7B) provided for the vehicle-installed system 3 (7) about the relay 5 (9). Thus, the different specifications 3A and 3B (7A and 7B) provided for the vehicle-installed system 3 (7) can be covered and unassigned installation sockets of the relay elements for implementing the specifications of the relay 5 (9) for the unselected specifications of the vehicle-installed system 3 (7) can be decreased and the vehicle-installed relay box 1 can be miniaturized.

Here, specifically the vehicle-installed relay box 200 in the related art example requires the installation sockets W1 to W4 (W5 and W6) for the four (two) relay elements about the relay 5 (9) of the vehicle-installed system 3 (7); in the embodiment, however, the vehicle-installed relay box 50 of the embodiment may be formed with the installation sockets S1 to S3 (S4) for the three (one) relay elements, the installation socket for each one relay element is decreased, waste of the space can be decreased accordingly, and the vehicle-installed relay box can be miniaturized. From the viewpoint of the whole vehicle-installed relay box 50, the installation sockets for two relay elements are decreased as compared with the vehicle-installed relay box 200 in the related art example.

The relay elements 5A₂, 5A₃, and 5B₁ (9A₁ and 9B₁) for implementing the specifications 5A and 5B (9A and 9B) of the relay 5 (9) are standardized to the same outer shape and the same outer dimensions, so that the installation socket of one relay element 5A₂, 5A₃, 5B₁ (9A₁, 9B₁) can also be easily used as the installation socket of another.

Since the relay elements 5A₂, 5A₃, and 5B₁ (9A₁ and 9B₁) are implemented as the semiconductor relays, they can be easily standardized to the same outer shape and the same outer dimensions.

Usually, the package sizes of the semiconductor relays are standardized and the semiconductor relays involve no limitation on the installation socket depending on the outer shape unlike mechanical relays and a large number of manufacturers manufacture the semiconductor relays having various types of performance. Thus, the semiconductor relays are fitted for use for the purpose of standardization of the relay elements 5A₂, 5A₃, and 5B₁ (9A₁ and 9B₁) to the same outer shape and the same outer dimensions. Since the semiconductor relays do not involve limitation caused by the contact life as with mechanical relays, optimum relay elements can be selected without being bound by the limitation, and standardization of the relay elements 5A₂, 5A₃, and 5B₁ (9A₁ and 9B₁) to the same outer shape and the same outer dimensions can be accomplished.

According to the invention, the installation sockets of the relay elements for implementing the specifications corresponding to a plurality of areas where the vehicle is to be used about a plurality of relays are formed in such a manner that the installation sockets of the relay elements for implementing the specifications corresponding to one of the plurality of areas where the vehicle is to be used assumed for each of the plurality of relays also serve as the installation sockets of the relay elements for implementing the specifications corresponding to another one of the plurality of areas where the vehicle is to be used for other relays. Thus, the plurality of areas where the vehicle is to be used can be covered and unassigned installation sockets of the relay elements for implementing the specifications corresponding to the area where the vehicle is to be used unselected for the installed relays can be decreased and the vehicle-installed relay box can be miniaturized.

According to the invention, the installation sockets of the relay elements for implementing the specifications for each type of different specifications of the vehicle-installed system about the relay are formed in such a manner that the installation socket of the relay element for implementing the specifications for the specifications, one type of different specifications provided for the vehicle-installed system to which controlling power supply is applied about the relay also serves as the installation socket of the relay element for implementing the specifications for the specifications, another type of different specifications of the vehicle-installed system about the relay. Thus, the different specifications of the vehicle-installed system can be covered and unassigned installation sockets of the relay elements for implementing the specifications for the unselected specifications of the vehicle-installed system can be decreased and the vehicle-installed relay box can be miniaturized.

According to the invention, the relay elements are standardized to the same outer shape and the same outer dimensions, so that the installation socket of one relay element can also be easily used as the installation socket of another.

According to the invention, the relay elements are implemented as semiconductor relays, so that they can be easily standardized to the same outer shape and the same outer dimensions.

Although the present invention has been shown and described with reference to specific embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A vehicle-installed relay box for installing a relay used for controlling power supply to a load in a vehicle-installed system provided with different specifications, the relay being configured to different specifications using one or more relay elements in combination in accordance with one type of specification selected from among the different specifications of the vehicle-installed system, the vehicle-installed relay box comprising:
a plurality of terminals;
an installation socket configured to install the relay element; and
a wiring configured to connect the relay element installed in the installation socket and the terminals,
wherein the installation socket is further configured to be installed a different relay element in accordance with the selected type of specification from among the different specifications of the vehicle-installed system.

2. The vehicle-installed relay box as claimed in claim 1, wherein the specifications of the relay is selected in accordance with an area where the vehicle is to be used.

3. The vehicle-installed relay box as claimed in claim 1, wherein each of the relay elements to be installed in the installation socket is configured to have same outer shape and outer dimensions.

4. The vehicle-installed relay box as claimed in claim 1, wherein the relay elements to be installed in the installation socket comprises a semiconductor relays.

5. The vehicle-installed relay box as claimed in claim 1, wherein the vehicle-installed relay box comprises a plurality of the installation sockets.

6. The vehicle-installed relay box as claimed in claim 1 further comprising a semiconductor module having a case provided the installation socket.
